(19) United States
(12) Patent Application Publication
(10) Pub. No.: US 2026/0121307 A1
(43) Pub. Date: Apr. 30, 2026

(54) WIRELESS SIGNAL APPARATUS AND WIRELESS SIGNAL DETECTION METHOD

(71) Applicant: RichWave Technology Corp., Taipei (TW)

(72) Inventor: Tse-Peng Chen, Taipei (TW)

(73) Assignee: RichWave Technology Corp., Taipei (TW)

(21) Appl. No.: 19/198,157

(22) Filed: May 5, 2025

Related U.S. Application Data
(60) Provisional application No. 63/713,064, filed on Oct. 29, 2024.

(30) Foreign Application Priority Data
Feb. 27, 2025 (TW) 114107300

(51) Int. Cl. H01Q 25/00; H01Q 21/06; H04B 1/40

(52) U.S. Cl. CPC H01Q 25/002; H01Q 21/065; H04B 1/40

(57) ABSTRACT

A wireless signal apparatus and a wireless signal detection are provided. The wireless signal apparatus comprises an antenna apparatus. The antenna apparatus comprises a transmitting antenna array and a receiving antenna array arranged in a first plane. The antenna apparatus forms a narrow-beamwidth antenna radiation pattern, the narrow-beamwidth antenna radiation pattern forms a flattened detection area, and the flattened detection area forms a second plane substantially perpendicular to the first plane. The wireless signal apparatus is configured to detect spatial information of an external object within the flattened detection area, and the spatial information comprises only two-dimensional spatial information in the second plane.

### CROSS-REFERENCE TO RELATED APPLICATION

This application claims the priority benefit of U.S. provisional application Ser. No. 63/713,064, filed on Oct. 29, 2024 and Taiwan application serial no. 114107300, filed on Feb. 27, 2025. The entirety of each of the above-mentioned patent applications is hereby incorporated by reference herein and made a part of this specification.

### BACKGROUND

### Technical Field

The disclosure relates to a wireless signal technology, and in particular relates to a wireless signal apparatus and a wireless signal detection method.

### Description of Related Art

Wireless signal technology has been developed for many years. According to the type of transmitted signal, wireless signals include pulse signals and continuous wave signals. With the rapid development of technology, frequency modulated continuous wave (FMCW) signals have been widely used in various fields in recent years. For example, FMCW signals are applied to the touch field for gesture detection. However, currently gesture detection has the problem of poor recognition accuracy, and there is still room for improvement.

### SUMMARY

A wireless signal apparatus and a wireless signal detection method, which may effectively improve the accuracy of touch sensing, are provided in the disclosure.

A wireless signal apparatus of the disclosure includes an antenna apparatus, a transmitting circuit, and a receiving circuit. The antenna apparatus is configured to form a narrow-beamwidth antenna radiation pattern. The antenna apparatus includes a transmitting antenna array and a receiving antenna array. The transmitting antenna array is arranged in a first plane and is configured to transmit a transmission signal. The receiving antenna array is arranged in the first plane and is configured to receive a reflected signal, and the reflected signal is generated by the transmission signal being reflected by an external object. The transmitting circuit is configured to generate the transmission signal. The receiving circuit is configured to generate an internal signal according to the reflected signal, and the internal signal is related to spatial information of the external object. The narrow-beamwidth antenna radiation pattern forms a flattened detection area, the flattened detection area forms a second plane, and a first included angle between the first plane and the second plane is greater than or equal to 80 degrees and less than or equal to 100 degrees. The wireless signal apparatus is configured to detect the spatial information of the external object within the flattened detection area, and the spatial information only includes two-dimensional spatial information in the second plane.

A wireless signal detection method is also provided in the disclosure. The wireless signal detection method includes the following operation. A narrow-beamwidth antenna radiation pattern is formed, in which the narrow-beamwidth antenna radiation pattern forms a flattened detection area, and the flattened detection area forms a second plane. A transmission signal is transmitted. A reflected signal is received, in which the reflected signal is generated by the transmission signal being reflected by an external object, and the external object is located in the flattened detection area. An internal signal is generated according to the reflected signal, in which the internal signal is related to spatial information of the external object, and the spatial information only includes two-dimensional spatial information in the second plane.

Based on the above, the antenna apparatus of the wireless signal apparatus of the embodiment of the disclosure includes a transmitting antenna array and a receiving antenna array arranged in a first plane. The antenna apparatus may form a narrow-beamwidth antenna radiation pattern. The narrow-beamwidth antenna radiation pattern may form a flattened detection area. The flattened detection area forms a second plane substantially perpendicular to the first plane. The wireless signal apparatus may be configured to detect spatial information of an external object in the flattened detection area, in which the spatial information only includes two-dimensional spatial information in the second plane. In this way, by using the antenna apparatus to detect only the two-dimensional spatial information of the external object in the flattened detection area in the second plane, the detection error in the third dimension caused by detecting the three-dimensional spatial information may be reduced, so as to improve the accuracy of touch sensing and reduce the amount of information calculation data.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a wireless signal apparatus generating a flattened detection area according to an embodiment of the disclosure.

FIG. 2 is a schematic diagram of an antenna apparatus according to an embodiment of the disclosure.

FIG. 3 is a schematic diagram of a radiation area of a narrow-beamwidth antenna radiation pattern in a YZ plane according to an embodiment of the disclosure.

FIG. 4 is a schematic diagram of a narrow-beamwidth antenna radiation pattern according to an embodiment of the disclosure.

FIG. 5 is a schematic diagram of a touch operation of an external object according to an embodiment of the disclosure.

FIG. 6 is a schematic diagram of a wireless signal apparatus according to an embodiment of the disclosure.

FIG. 7 is a schematic diagram of an antenna apparatus according to another embodiment of the disclosure.

FIG. 8 is a schematic diagram of a wireless signal apparatus according to another embodiment of the disclosure.

FIG. 9 is a schematic diagram of a wireless signal apparatus according to yet another embodiment of the disclosure.

FIG. 10 and FIG. 11 are flowcharts of a wireless signal detection method according to an embodiment of the disclosure.

### DETAILED DESCRIPTION OF DISCLOSED EMBODIMENTS

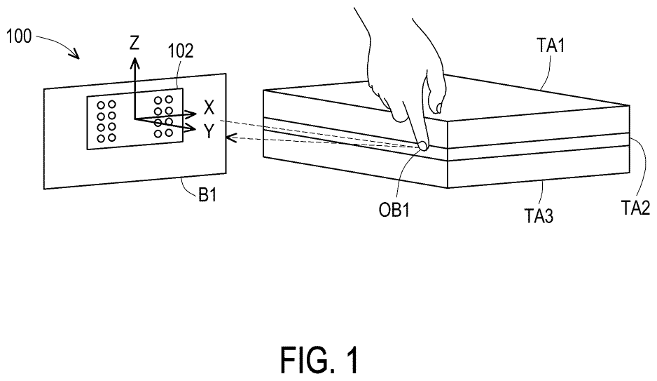

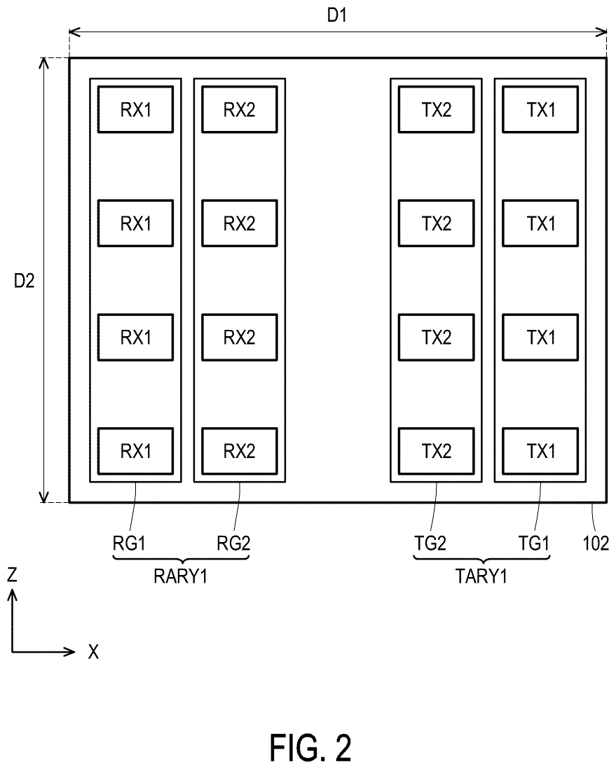

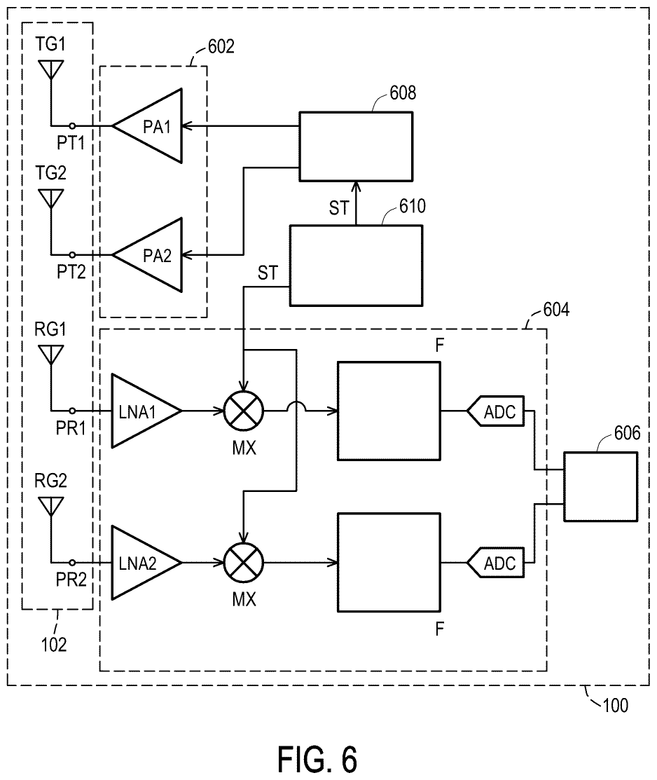

FIG. 1 is a schematic diagram of a wireless signal apparatus generating a flattened detection area according to an embodiment of the disclosure, FIG. 2 is a schematic diagram of an antenna apparatus according to an embodiment of the disclosure, and FIG. 6 is a schematic diagram of a wireless signal apparatus according to an embodiment of the disclosure. Referring to FIG. 1, FIG. 2 and FIG. 6 simultaneously, the wireless signal apparatus 100 may include an antenna apparatus 102, a transmitting circuit 602, and a receiving circuit 604. The antenna apparatus 102, the transmitting circuit 602, and the receiving circuit 604 may be integrated into a wireless signal chip and disposed on the substrate B1. The wireless signal apparatus 100 may be, for example, a radar apparatus. The antenna apparatus 102 may include a transmitting antenna array TARY1 and a receiving antenna array RARY1 (shown in FIG. 2) arranged in a first plane. The first plane is, for example, the XZ plane shown in FIG. 1 and FIG. 2. For example, the transmitting antenna array TARY1 and the receiving antenna array RARY1 may form a rectangular antenna array and are disposed on a substrate having side lengths D1 and D2. The side length D1 may be, for example, 12 mm, and the side length D2 may be, for example, 10 mm, but the disclosure is not limited thereto. The transmitting antenna array TARY1 is configured to transmit the transmission signal, and the receiving antenna array RARY1 is configured to receive the reflected signal generated by the transmission signal being reflected by the external object OB1 (e.g., a finger, but not limited thereto). The antenna apparatus 102 may be configured to form a narrow-beamwidth antenna radiation pattern. The narrow-beamwidth antenna radiation pattern forms a flattened detection area. The flattened detection area forms a second plane. The second plane is substantially perpendicular to the first plane. Furthermore, the included angle between the first plane and the second plane may be, for example, greater than or equal to 80 degrees and less than or equal to 100 degrees. In this embodiment, the second plane may be, for example, the XY plane shown in FIG. 1. The wireless signal apparatus 100 may be configured to detect spatial information of the external object OB1 within the flattened detection area. The spatial information only includes two-dimensional spatial information in a second plane (e.g., an XY plane) formed by the flattened detection area.

In this embodiment, at least one of the transmitting antenna array TARY1 and the receiving antenna array RARY1 includes multiple antenna units arranged along a first direction in the first plane. The first direction in the first plane is substantially parallel to the normal direction of the second plane. Specifically, the included angle between the first direction and the normal direction of the second plane is greater than or equal to 0 degrees and less than or equal to 10 degrees. In this embodiment, the first direction may be, for example, the Z-axis direction shown in FIG. 1 and FIG. 2, and the second plane may be, for example, the XY plane shown in FIG. 1. Specifically, the transmitting antenna array TARY1 may include one or more transmitting antenna groups, and if the transmitting antenna array TARY1 includes multiple transmitting antenna groups, the multiple transmitting antenna groups are arranged along the second direction in the first plane or substantially along the second direction in the first plane. On the other hand, the receiving antenna array RARY1 may include multiple receiving antenna groups arranged along the second direction or substantially along the second direction. The second direction is substantially perpendicular to the normal direction of the second plane. Specifically, an included angle between the second direction and the normal direction of the second plane is greater than or equal to 80 degrees and less than or equal to 100 degrees. In this embodiment, the second direction may be, for example, the X-axis direction shown in FIG. 1 and FIG. 2, and the second plane may be, for example, the XY plane shown in FIG. 1. For example, as shown in FIG. 2, in this embodiment, the transmitting antenna array TARY1 includes transmitting antenna groups TG1 and TG2 arranged along the X-axis direction, and the receiving antenna array RARY1 includes receiving antenna groups RG1 and RG2 arranged along the X-axis direction.

Furthermore, in this embodiment, the transmitting antenna group TG1 includes multiple transmitting antenna units TX1 arranged along a first direction (e.g., the Z-axis direction), the transmitting antenna group TG2 includes multiple transmitting antenna units TX2 arranged along the first direction, the receiving antenna group RG1 includes multiple receiving antenna units RX1 arranged along the first direction, and the receiving antenna group RG2 includes multiple receiving antenna units RX2 arranged along the first direction. The transmitting antenna units TX1 and TX2 and the receiving antenna units RX1 and RX2 may be, for example, patch antennas, but are not limited thereto.

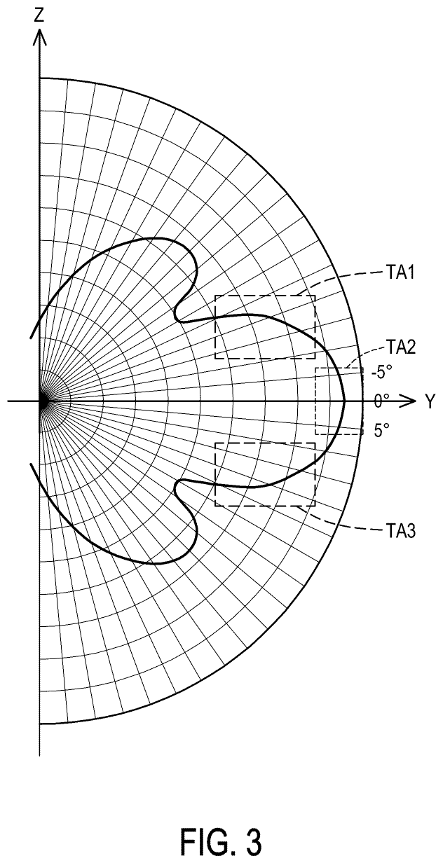

The transmitting antenna groups TG1 and TG2 may respectively transmit a first sub-transmission signal and a second sub-transmission signal (the transmission signal transmitted by the transmitting antenna array TARY1 includes the first sub-transmission signal and the second sub-transmission signal), thereby forming a narrow-beamwidth antenna radiation pattern. In this embodiment, each transmitting antenna group of the transmitting antenna array TARY1 respectively includes four transmitting antenna units arranged along a first direction (e.g., the Z-axis direction) or substantially along the first direction, and each receiving antenna group of the receiving antenna array RARY1 respectively includes four receiving antenna units arranged along the first direction or substantially along the first direction. However, in other embodiments, it is also possible that only at least one of the transmitting antenna array TARY1 and the receiving antenna array RARY1 includes multiple antenna units arranged along the first direction or substantially along the first direction, without requiring that both the transmitting antenna array TARY1 and the receiving antenna array RARY1 include multiple antenna units arranged along the first direction or substantially along the first direction. It is worth noting that in the antenna apparatus 102, when the number of antenna units arranged along the first direction or substantially along the first direction increases, the range of the antenna radiation pattern formed by the antenna apparatus 102 in the first direction may be reduced accordingly, thereby forming a narrow-beamwidth antenna radiation pattern, such as the narrow-beamwidth antenna radiation pattern shown in FIG. 1 and FIG. 3. Furthermore, it should be noted that if an antenna radiation pattern with a narrower beam is desired to be formed in the first direction, a considerable number of antenna units must be disposed in the first direction, which may increase the size of the antenna apparatus 102. However, the required size of the antenna apparatus 102 may be controlled by selecting a suitable frequency band. For example, the frequency band used by the wireless signal apparatus 100 may be a frequency band above 24 GHZ, so that the size of the antenna apparatus 102 may be reduced while achieving the same performance, which is beneficial to the application of wearable displays with limited size (e.g., smart watches and head-mounted display devices).

Specifically, referring to FIG. 1 and FIG. 3 at the same time, FIG. 3 is a schematic diagram of a radiation area of a narrow-beamwidth antenna radiation pattern in a YZ plane according to an embodiment of the disclosure. The narrow-beamwidth antenna radiation pattern includes a first radiation area TA1, a second radiation area TA2 and a third radiation area TA3. The second radiation area TA2 is located between the first radiation area TA1 and the third radiation area TA3. The range of the first radiation area TA1 is greater than the second radiation area TA2, and the range of the third radiation area TA3 is greater than the second radiation area TA2. The second radiation area TA2 forms the aforementioned flattened detection area. The distribution of the narrow-beamwidth antenna radiation pattern in the YZ plane may be shown in FIG. 3. For example, the second radiation area TA2 may be defined as within a range of positive or negative 5 degrees relative to the Y axis. For example, the first radiation area TA1 and the third radiation area TA3 may be defined as being located at a position greater than 5 degrees and less than negative 5 degrees relative to the Y axis, respectively.

As mentioned above, the transmitting antenna array TARY1 is configured to transmit the transmission signal, and the receiving antenna array RARY1 is configured to receive the reflected signal generated by the transmission signal being reflected by the external object OB1. When the external object OB1 is located in the first radiation area TA1 or the third radiation area TA3, the level of the reflected signal generated by the reflection of the external object OB1 is less than the predetermined threshold, and when the external object OB1 is located in the second radiation area TA2, the level of the reflected signal generated by the reflection of the external object OB1 is greater than or equal to the predetermined threshold. Therefore, by comparing the level of the reflected signal with the predetermined threshold, it may be determined whether the external object OB1 touches the flattened detection area formed by the second radiation area TA2. In this way, the touch sensing range of the wireless signal apparatus 100 may be limited to the flattened detection area formed by the second radiation area TA2, thereby preventing the portion of the external object OB1 that is not used to perform touch operations (e.g., a palm, but not limited thereto) from affecting the accuracy of the touch operation when the portion is located in the first radiation area TA1 or the third radiation area TA3. This is further explained in the following paragraphs.

The transmitting circuit 602 and the receiving circuit 604 of the wireless signal apparatus 100 may be implemented as shown in FIG. 6. In addition, the wireless signal apparatus 100 may also include a processing circuit 606, a phase shifter 608, and a frequency synthesizer 610. The transmitting circuit 602 includes power amplifiers PA1 and PA2, and the receiving circuit 604 includes low-noise amplifiers LNA1 and LNA2. In addition, the receiving circuit 604 may further include a mixer MX, a filter F, and an analog-to-digital converter ADC. The transmitting circuit 602 is coupled to the phase shifter 608. The frequency synthesizer 610 is coupled to the phase shifter 608 and the receiving circuit 604. The receiving circuit 604 is further coupled to the processing circuit 606.

The transmitting circuit 602 is configured to generate a transmission signal, and the receiving circuit 604 is configured to generate an internal signal according to a reflected signal generated by the transmission signal being reflected by the external object OB1. The internal signal is related to the spatial information of the external object OB1, that is, the two-dimensional spatial information in the plane formed by the flattened detection area.

Furthermore, the antenna apparatus 102 of the wireless signal apparatus 100 may also include transmitting antenna ports PT1 and PT2 and receiving antenna ports PR1 and PR2. The transmitting antenna groups TG1 and TG2 are respectively coupled to the transmitting antenna ports PT1 and PT2 and the receiving antenna groups RG1 and RG2 are respectively coupled to the receiving antenna ports PR1 and PR2. The power amplifiers PA1 and PA2 may be respectively coupled to the transmitting antenna groups TG1 and TG2 via the transmitting antenna ports PT1 and PT2, and the low-noise amplifiers LNA1 and LNA2 may be respectively coupled to the receiving antenna groups RG1 and RG2 via the receiving antenna ports PR1 and PR2. The frequency synthesizer 610 may generate a carrier signal ST. The power amplifiers PA1 and PA2 may respectively transmit the first sub-transmission signal and the second sub-transmission signal externally through the transmitting antenna groups TG1 and TG2. The low-noise amplifiers LNA1 and LNA2 may receive the first sub-reflected signal and the second sub-reflected signal via the receiving antenna ports PR1 and PR2 (the reflected signal received by the receiving antenna array RARY1 includes the first sub-reflected signal and the second sub-reflected signal). The angle information of the external object OB1 in the XY plane (the second plane) may be determined according to the first sub-reflected signal and the second sub-reflected signal. The position information of the external object OB1 in the XY plane may be determined by the angle information and distance information determined by the first sub-reflected signal and the second sub-reflected signal (the aforementioned two-dimensional spatial information includes the position information of the external object OB1 in the XY plane). Therefore, in order to obtain the angle information of the external object OB1 in the XY plane (the second plane), the antenna apparatus 102 must include at least two receiving antenna ports PR1 and PR2, and the receiving antenna array RARY1 must include at least two receiving antenna groups RG1 and RG2, and the receiving antenna groups RG1 and RG2 are preferably arranged along the second direction (e.g., the X-axis direction) or substantially along the second direction. On the other hand, if the receiving antenna groups RG1 and RG2 are arranged along the first direction (e.g., the Z-axis direction), the angle information obtained is in the YZ plane, which is negligible (e.g., unnecessary) information for the present technology.

In this embodiment, the mixer MX is coupled to the low-noise amplifiers LNA1 and LNA2, the frequency synthesizer 610 and the filter F. The mixer MX may mix the radio frequency signals output by the low-noise amplifiers LNA1 and LNA2 according to the carrier signal ST generated by the frequency synthesizer 610 to generate an intermediate frequency signal. The filter F is configured to filter out the frequency components other than the intermediate frequency signal. The analog-to-digital converter ADC is coupled between the filter F and the processing circuit 606, and the analog-to-digital converter ADC is configured to generate a baseband signal according to the intermediate frequency signal. In this embodiment, two mixers MX, two filters F, and two analog-to-digital converters ADC are used. The two mixers MX are respectively coupled between the low-noise amplifiers LNA1 and LNA2 and the two filters F, and the two filters F are respectively coupled between the two mixers MX and the two analog-to-digital converters ADC, but the disclosure is not limited thereto.

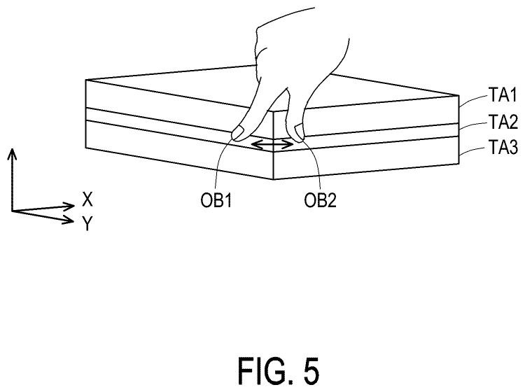

The processing circuit 606 may determine the spatial information of the external object according to the baseband signal, such as the touch operation of the external object in the flattened detection area formed by the second radiation area TA2 in the embodiments of FIG. 1 and FIG. 5. When the wireless signal apparatus 100 is applied to a display device, the processing circuit 606 may also control the display device to display a corresponding image. For example, when the external object OB1 of the embodiment of FIG. 1 (e.g., a finger in this embodiment) is located in the second radiation area TA2, the processing circuit 606 may generate position information according to the internal signal (e.g., a baseband signal). The display device displays a mark (e.g., a cursor, but not limited thereto) corresponding to the external object OB1 according to the position information, and when the external object OB1 is located in the first radiation area TA1 or the third radiation area TA3, the display device does not display the mark. That is, the wireless signal apparatus 100 of this embodiment is configured such that when the external object OB1 is located in the first radiation area TA1 or the third radiation area TA3, the level of the reflected signal generated by the reflection of the external object OB1 is less than a predetermined threshold, and when the external object OB1 is located in the second radiation area TA2, the level of the reflected signal generated by the reflection of the external object OB1 is greater than or equal to the predetermined threshold. The predetermined threshold represents the reflected signal level threshold sufficient to display a mark on the display device. Such a setting enables the wireless signal apparatus 100 to achieve the effect of detecting only the external object OB1 located in the second radiation area TA2, so as to obtain two-dimensional spatial information of the external object OB1 in the XY plane (second plane), but not including the third-dimensional spatial information (e.g., information in the Z-axis direction). Since the wireless signal apparatus 100 of this embodiment only obtains two-dimensional spatial information in the XY plane (second plane), the XY plane (second plane) may be regarded as a virtual touch plane, and the external object OB1 may perform touch operations in the virtual touch plane. In this way, the misjudgment behavior of the external object OB1 when it moves in the three-dimensional direction (e.g., the Z-axis direction) but has not yet touched the second radiation area TA2, and the misjudgment behavior of the aforementioned portion of the external object OB1 that is not used to perform touch operations (e.g., the palm, but not limited thereto) when it is located in the first radiation area TA1 or the third radiation area TA3 may be reduced, so as to reduce the detection error, thereby improving the accuracy of the touch operation of the external object OB1, and at the same time reducing the amount of information calculation data performed by the processing circuit 606.

It is worth noting that the above-mentioned flattened detection area is not limited to detecting only a single object. For example, in the embodiment of FIG. 5, the external object may include two objects, such as external objects OB1 and OB2. The flattened detection area may also detect external objects OB1 and OB2 (e.g., two fingers in this embodiment). For example, in the embodiment of FIG. 5, touch operations with the index finger and thumb of the user may be performed. When the external objects OB1 and OB2 are located in the second radiation area TA2, the processing circuit 606 may generate the respective position information (the aforementioned two-dimensional spatial information includes the respective position information of the external objects OB1 and OB2 in the XY plane) of the external objects OB1 and OB2 in the XY plane (the second plane) according to the internal signal (e.g., the baseband signal), and may be configured to generate relative distance information of the external objects OB1 and OB2. For example, after obtaining the relative distance information of the external objects OB1 and OB2 in the XY plane, the relative distance information may be further configured to form a corresponding zoom command, so that the display device controls the displayed image to present a zoom-in or zoom-out effect according to the zoom command. In other embodiments, the relative distance information may also be configured to form other types of commands.

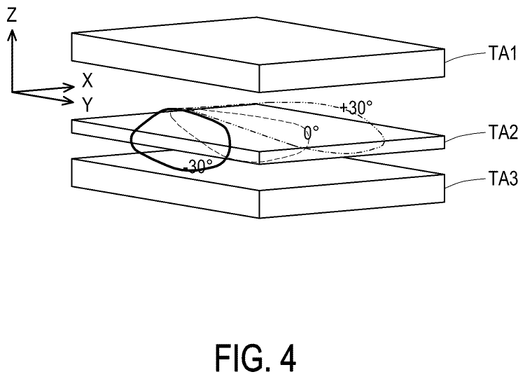

In addition, in the embodiment of FIG. 6, the phase shifter 608 is coupled to the transmitting antenna groups TG1 and TG2 via the transmitting circuit 602. The phase shifter 608 may be configured to change the phase difference between the first sub-transmission signal and the second sub-transmission signal, so that the distribution of the narrow-beamwidth antenna radiation field pattern may be rotated and changed around an axis extending along the first direction (e.g., the Z axis), as shown in FIG. 4. FIG. 4 is a schematic diagram of a narrow-beamwidth antenna radiation pattern according to an embodiment of the disclosure. It should be noted that in order to clearly represent the distribution of the narrow-beamwidth antenna radiation pattern in the second plane (XY plane) formed by the flattened detection area formed by the second radiation area TA2, the first radiation area TA1 and the third radiation area TA3 are illustrated in the form of an exploded diagram. As shown in FIG. 4, the distribution of the narrow-beamwidth antenna radiation pattern in the XY plane (second plane) is, for example, a rotation variation of 30 degrees, 0 degrees, and −30 degrees in the XY plane with the Z axis as the center axis, but not limited thereto. In this way, by changing the distribution range of the narrow-beamwidth antenna radiation pattern in the XY plane, the detection range of the wireless signal apparatus 100 may be adjusted, thereby more effectively and accurately detecting the position of the external object OB1 on the flattened detection area. On the other hand, in other embodiments, for example, when there is no need to change the distribution range of the narrow-beamwidth antenna radiation pattern in the XY plane, or when other methods or elements are used to change the phase difference between the first sub-transmission signal and the second sub-transmission signal, the phase shifter 608 in the wireless signal apparatus 100 may also be omitted.

It should be noted that the embodiment of FIG. 6 is described by taking the antenna apparatus 102 including two transmitting antenna groups TG1 and TG2 and two receiving antenna groups RG1 and RG2 as an example, but the number of transmitting antenna groups and receiving antenna groups included in the antenna apparatus 102 is not limited thereto. In other embodiments, when the number of transmitting antenna groups arranged along the second direction or substantially along the second direction increases, the range of the narrow-beamwidth antenna radiation pattern in the second direction (e.g., the X-axis direction) is reduced accordingly. In this way, the antenna radiation pattern may be adjusted to a suitable antenna radiation pattern according to the application scenario of the wireless signal apparatus 100, for example, it is applied to a situation where an external object OB1 within a known specific direction or a specific range is to be detected.

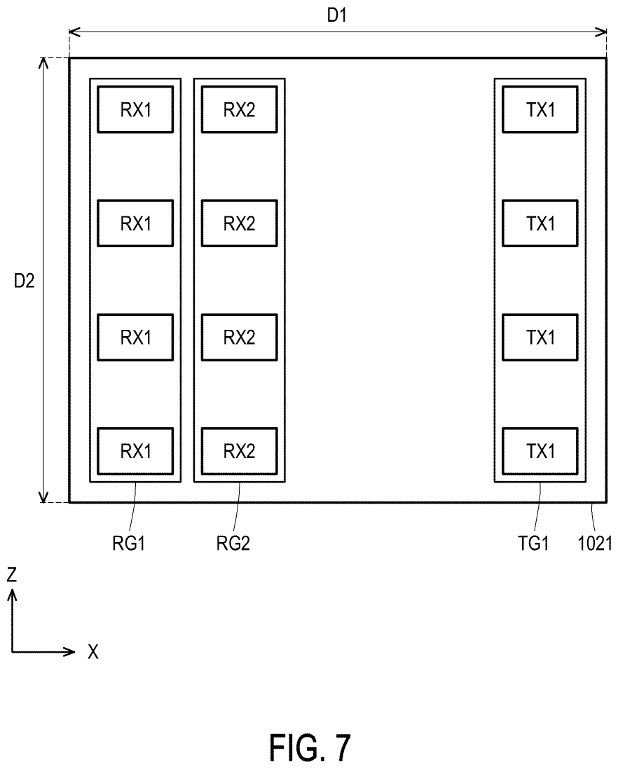

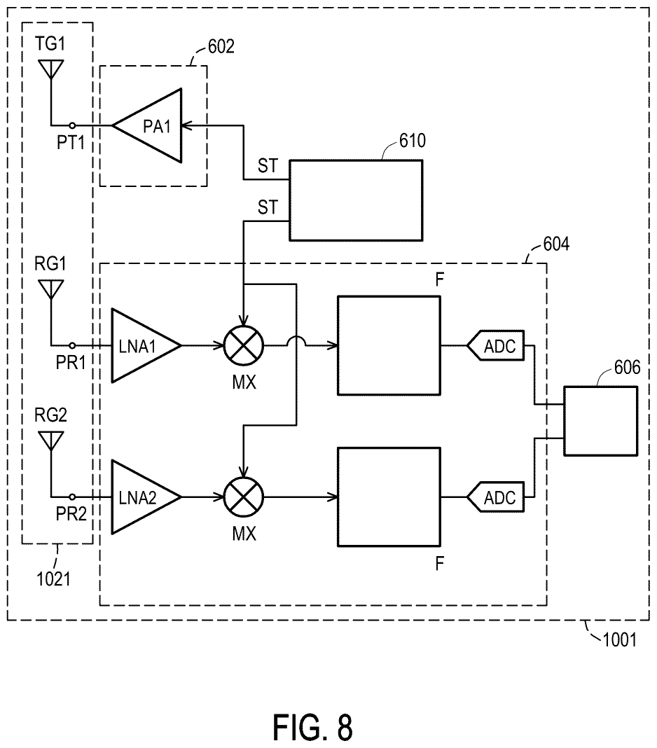

In addition, referring to FIG. 7, FIG. 7 is a schematic diagram of an antenna apparatus according to another embodiment of the disclosure. In the embodiment of FIG. 7, the antenna apparatus 1021 includes one transmitting antenna group TG1, two receiving antenna groups RG1 and RG2, one transmitting antenna port PT1, and two receiving antenna ports PR1 and PR2. In addition, the transmitting circuit 602 and the receiving circuit 604 may be implemented in a manner as shown in FIG. 8. FIG. 8 is a schematic diagram of a wireless signal apparatus according to another embodiment of the disclosure. Compared to the embodiment of FIG. 6, the transmitting circuit 602 of the wireless signal apparatus 1001 of the embodiment of FIG. 8 includes a power amplifier PA1 but does not include a power amplifier PA12, and the wireless signal apparatus 1001 is not provided with a phase shifter 608. The embodiments of FIG. 7 and FIG. 8 use a relatively simple structure to implement the technology of detecting the two-dimensional spatial information of the external object in the flattened detection area in the second plane.

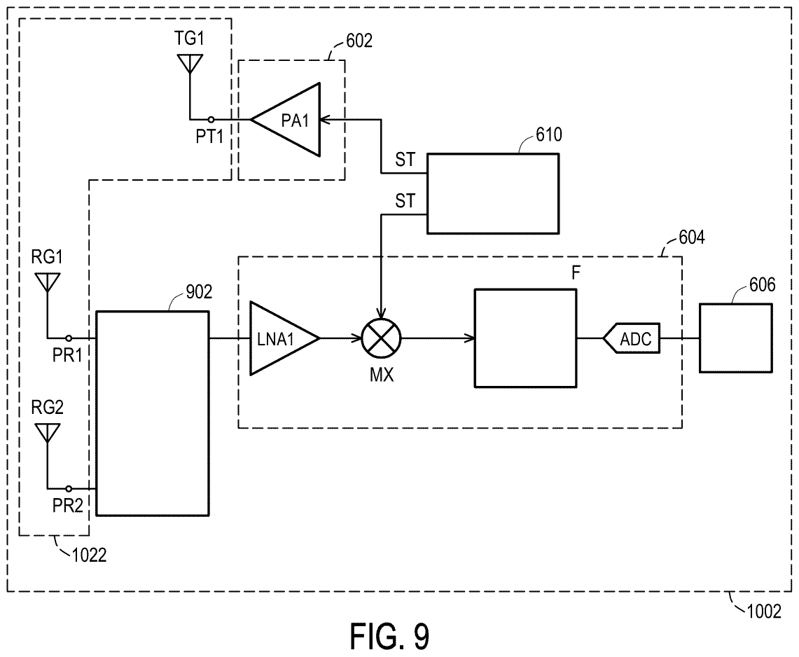

In some examples, the receiving circuit 604 may also be as shown in the embodiment of FIG. 9. FIG. 9 is a schematic diagram of a wireless signal apparatus according to yet another embodiment of the disclosure. The antenna apparatus 1022 of FIG. 9 is similar to the antenna apparatus 1021 of FIG. 8. The antenna apparatus 1022 includes one transmitting antenna group TG1, two receiving antenna groups RG1 and RG2, one transmitting antenna port PT1, and two receiving antenna ports PR1 and PR2. The difference between the embodiment of FIG. 9 and the embodiment of FIG. 8 is that the wireless signal apparatus 1002 of FIG. 9 may further include a switching circuit 902. In addition, the receiving circuit 604 of FIG. 9 does not include a low-noise amplifier LNA2, and the receiving circuit 604 may only use one set of mixer MX, filter F, and analog-to-digital converter ADC. The switching circuit 902 is coupled between the receiving antenna groups RG1 and RG2 and the receiving circuit 604. The switching circuit 902 may be composed of electrical components such as one or more multiplexers and switches, and the low-noise amplifier LNA1 may be quickly switched to be coupled to the receiving antenna group RG1 or RG2 through the switching circuit 902. That is, the switching circuit 902 is coupled to the low-noise amplifier LNA1 and selects to couple the receiving antenna group RG1 to the low-noise amplifier LNA1 via the receiving antenna port PR1, or to couple the receiving antenna group RG2 to the low-noise amplifier LNA1 via the receiving antenna port PR2, so that the receiving circuit 604 does not need to use another low-noise amplifier LNA2 and another set of mixer MX, filter F, and analog-to-digital converter ADC, which contributes to the reduction of circuit area.

Since the implementation of the embodiments of FIG. 7 to FIG. 9 is similar to the implementation of the embodiments of FIG. 1 to FIG. 6, a person skilled in the art should be able to infer the implementation of the embodiments of FIG. 7 to FIG. 9 based on the contents of the embodiments of FIG. 1 to FIG. 6, thus details are not repeated herein.

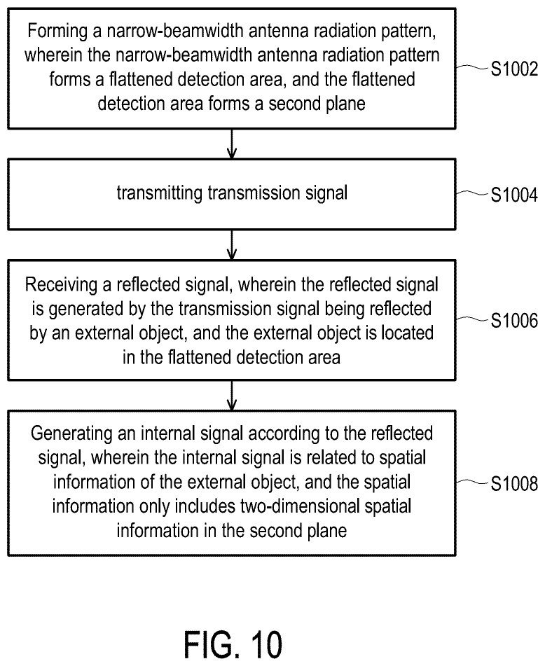

FIG. 10 is a flowchart of a wireless signal detection method according to an embodiment of the disclosure. The wireless signal detection method may be, for example, a radar detection method. As may be seen from the above embodiments, the wireless signal detection method may at least include the following steps. First, a narrow-beamwidth antenna radiation pattern is formed. The narrow-beamwidth antenna radiation pattern forms a flattened detection area, and the flattened detection area forms a second plane (step S1002). A transmission signal is transmitted via the transmitting antenna array (step S1004). The receiving antenna array receives a reflected signal. The reflected signal is generated by the transmission signal being reflected by an external object, and the external object is located in the flattened detection area (step S1006). Then, an internal signal is generated according to the reflected signal, in which the internal signal is related to spatial information of the external object, and the spatial information only includes two-dimensional spatial information in the second plane (step S1008).

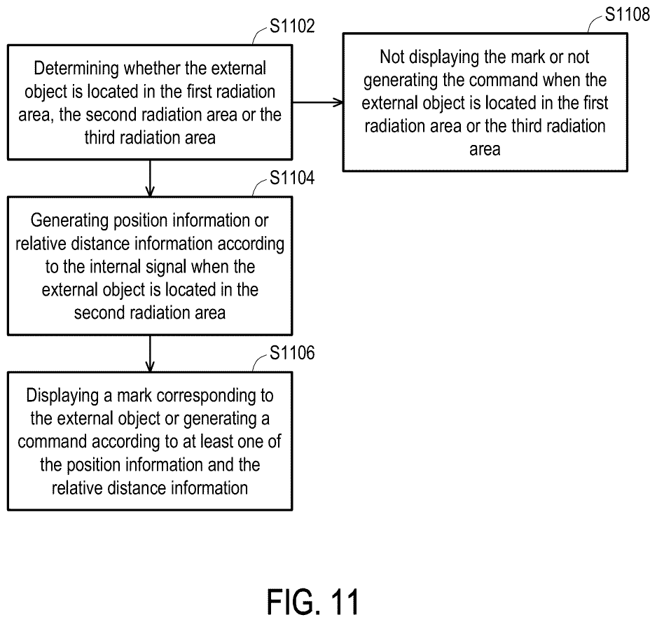

Furthermore, the narrow-beamwidth antenna radiation pattern includes a first radiation area, a second radiation area and a third radiation area. The second radiation area is located between the first radiation area and the third radiation area. The range of the first radiation area is greater than the second radiation area, and the range of the third radiation area is greater than the second radiation area. The second radiation area forms the flattened detection area. The wireless signal detection method of external objects using the first radiation area, the second radiation area and the third radiation area may be shown in FIG. 11. First, whether the external object is located in the first radiation area, the second radiation area or the third radiation area is determined (step S1102). When the external object is located in the second radiation area, position information or relative distance information in the second plane is generated according to the internal signal (step S1104), in which the relative distance information is generated when the corresponding external object includes more than two objects. Then, a mark corresponding to the external object is displayed or a command is generated according to at least one of the position information and the relative distance information (step S1106). In addition, when the external object is located in the first radiation area or the third radiation area, no mark is displayed or no command is generated (step S1108).

Furthermore, in some embodiments, the step of transmitting the transmission signal via the transmitting antenna array may include: transmitting a first sub-transmission signal via a first transmitting antenna group, transmitting a second sub-transmission signal via a second transmitting antenna group. The first transmitting antenna group and the second transmitting antenna group are arranged along the second direction, and the transmission signal includes a first sub-transmission signal and a second sub-transmission signal. By changing the phase difference between the first sub-transmission signal and the second sub-transmission signal, the distribution of the narrow-beamwidth antenna radiation pattern in the second plane is rotated and changed around the axis extending along the first direction.

To sum up, the antenna apparatus of the wireless signal apparatus of the embodiment of the disclosure includes a transmitting antenna array and a receiving antenna array arranged in a first plane. The antenna apparatus forms a narrow-beamwidth antenna radiation pattern. The narrow-beamwidth antenna radiation pattern may form a flattened detection area. The flattened detection area forms a second plane substantially perpendicular to the first plane. The wireless signal apparatus may be configured to detect spatial information of an external object in the flattened detection area, in which the spatial information only includes two-dimensional spatial information in the second plane. In this way, by using the antenna apparatus to detect only the two-dimensional spatial information of the external object in the flattened detection area in the second plane, the detection error in the third dimension caused by detecting the three-dimensional spatial information may be reduced, so as to improve the accuracy of touch sensing and reduce the amount of information calculation data.

What is claimed is:

1. A wireless signal apparatus, comprising:
an antenna apparatus, configured to form a narrow-beamwidth antenna radiation pattern, the antenna apparatus comprising:
a transmitting antenna array, arranged in a first plane and configured to transmit a transmission signal; and
a receiving antenna array, arranged in the first plane, configured to receive a reflected signal, wherein the reflected signal is generated by the transmission signal being reflected by an external object;
a transmitting circuit, configured to generate the transmission signal; and
a receiving circuit, configured to generate an internal signal according to the reflected signal, wherein the internal signal is related to spatial information of the external object; wherein
the narrow-beamwidth antenna radiation pattern forms a flattened detection area, the flattened detection area forms a second plane, a first included angle between the first plane and the second plane is greater than or equal to 80 degrees and less than or equal to 100 degrees, the wireless signal apparatus is configured to detect the spatial information of the external object within the flattened detection area, the spatial information only comprises two-dimensional spatial information in the second plane.

2. The wireless signal apparatus according to claim 1, wherein the narrow-beamwidth antenna radiation pattern comprises a first radiation area, a second radiation area and a third radiation area, a level of the reflected signal that is generated is less than a predetermined threshold when the external object is located in the first radiation area or the third radiation area, and the level of the reflected signal that is generated is greater than or equal to the predetermined threshold when the external object is located in the second radiation area, the second radiation area is located between the first radiation area and the third radiation area, a range of the first radiation area is greater than the second radiation area, and a range of the third radiation area is greater than the second radiation area, the second radiation area forms the flattened detection area.

3. The wireless signal apparatus according to claim 2, further comprising a processing circuit, wherein the processing circuit is configured to generate a position information according to the internal signal when the external object is located in the second radiation area, a display device displays a mark corresponding to the external object according to the position information, and the display device does not display the mark when the external object is located in the first radiation area or the third radiation area.

4. The wireless signal apparatus according to claim 2, further comprising a processing circuit, wherein the external object comprises two objects, the processing circuit is configured to generate relative distance information of the two objects in the second plane according to the internal signal when the two objects are located in the second radiation area.

5. The wireless signal apparatus according to claim 1, wherein at least one of the transmitting antenna array and the receiving antenna array comprises a plurality of antenna units arranged along a first direction, a second included angle between the first direction and a normal direction of the second plane is greater than or equal to 0 degrees and less than or equal to 10 degrees.

6. The wireless signal apparatus according to claim 1, wherein the antenna apparatus further comprises a first receiving antenna port and a second receiving antenna port, the receiving antenna array comprises a first receiving antenna group and a second receiving antenna group arranged along a second direction and respectively coupled to the first receiving antenna port and the second receiving antenna port, a third included angle between the second direction and a normal direction of the second plane is greater than or equal to 80 degrees and less than or equal to 100 degrees.

7. The wireless signal apparatus according to claim 1, wherein the antenna apparatus further comprises a first transmitting antenna port, a first receiving antenna port and a second receiving antenna port, the transmitting antenna array comprises a first transmitting antenna group coupled to the first transmitting antenna port, the first transmitting antenna group comprises a plurality of first transmitting antenna units, the receiving antenna array comprises a first receiving antenna group and a second receiving antenna group respectively coupled to the first receiving antenna port and the second receiving antenna port, the first receiving antenna group comprises a plurality of first receiving antenna units, the second receiving antenna group comprises a plurality of second receiving antenna units, the first receiving antenna port receives a first sub-reflected signal, the second receiving antenna port receives a second sub-reflected signal, the reflected signal comprises the first sub-reflected signal and the second sub-reflected signal, angle information of the external object in the second plane is determined according to the first sub-reflected signal and the second sub-reflected signal.

8. The wireless signal apparatus according to claim 7, wherein the antenna apparatus further comprises a second transmitting antenna port, the transmitting antenna array further comprises a second transmitting antenna group coupled to the second transmitting antenna port, the second transmitting antenna group comprises a plurality of second transmitting antenna units.

9. The wireless signal apparatus according to claim 8, wherein the first transmitting antenna group and the second transmitting antenna group are arranged along a second direction, the first transmitting antenna group is configured to transmit a first sub-transmission signal, the second transmitting antenna group is configured to transmit a second sub-transmission signal, the transmission signal comprises the first sub-transmission signal and the second sub-transmission signal, a phase difference between the first sub-transmission signal and the second sub-transmission signal changes, so that distribution of the narrow-beamwidth antenna radiation pattern in the second plane is rotated and changed around an axis extending along a first direction, a second included angle between the first direction and a normal direction of the second plane is greater than or equal to 0 degrees and less than or equal to 10 degrees.

10. The wireless signal apparatus according to claim 9, further comprising a phase shifter coupled to the first transmitting antenna group and the second transmitting antenna group, wherein the phase shifter is configured to change the phase difference between the first sub-transmission signal and the second sub-transmission signal.

11. The wireless signal apparatus according to claim 1, wherein the antenna apparatus further comprises a plurality of transmitting antenna ports, the transmitting antenna array comprises a plurality of transmitting antenna groups arranged along a second direction and respectively coupled to the transmitting antenna ports.

12. The wireless signal apparatus according to claim 1, wherein a frequency band used by the wireless signal apparatus is greater than or equal to 24 GHz.

13. The wireless signal apparatus according to claim 7, wherein the transmitting circuit further comprises a first power amplifier, the receiving circuit further comprises a first low-noise amplifier and a second low-noise amplifier, the first transmitting antenna group is coupled to the first power amplifier via the first transmitting antenna port, the first receiving antenna group is coupled to the first low-noise amplifier via the first receiving antenna port, the second receiving antenna group is coupled to the second low-noise amplifier via the second receiving antenna port.

14. The wireless signal apparatus according to claim 7, further comprising a switching circuit, wherein the transmitting circuit further comprises a first power amplifier, the receiving circuit further comprises a first low-noise amplifier, the first transmitting antenna group is coupled to the first power amplifier via the first transmitting antenna port, the switching circuit is coupled to the first low-noise amplifier and selects to couple the first receiving antenna group to the first low-noise amplifier via the first receiving antenna port, or to couple the second receiving antenna group to the first low-noise amplifier via the second receiving antenna port.

15. The wireless signal apparatus according to claim 8, wherein the transmitting circuit further comprises a first power amplifier and a second power amplifier, the receiving circuit further comprises a first low-noise amplifier and a second low-noise amplifier, the first transmitting antenna group is coupled to the first power amplifier via the first transmitting antenna port, the second transmitting antenna group is coupled to the second power amplifier via the second transmitting antenna port, the first receiving antenna group is coupled to the first low-noise amplifier via the first receiving antenna port, the second receiving antenna group is coupled to the second low-noise amplifier via the second receiving antenna port.

16. The wireless signal apparatus according to claim 8, wherein the first transmitting antenna group comprises a plurality of first transmitting antenna units arranged along a first direction, the second transmitting antenna group comprises a plurality of second transmitting antenna units arranged along the first direction, the first receiving antenna group comprises a plurality of first receiving antenna units arranged along the first direction, the second receiving antenna group comprises a plurality of second receiving antenna units arranged along the first direction, the first transmitting antenna group, the second transmitting antenna group, the first receiving antenna group, and the second receiving antenna group are arranged along a second direction, the first direction is perpendicular to the second direction.

17. A wireless signal detection method, comprising:
forming a narrow-beamwidth antenna radiation pattern, wherein the narrow-beamwidth antenna radiation pattern forms a flattened detection area, and the flattened detection area forms a second plane;
transmitting a transmission signal;
receiving a reflected signal, wherein the reflected signal is generated by the transmission signal being reflected by an external object, and the external object is located in the flattened detection area; and
generating an internal signal according to the reflected signal, wherein the internal signal is related to spatial information of the external object, and the spatial information only comprises two-dimensional spatial information in the second plane.

18. The wireless signal detection method according to claim 17, wherein the narrow-beamwidth antenna radiation pattern comprises a first radiation area, a second radiation area and a third radiation area, the second radiation area is located between the first radiation area and the third radiation area, a range of the first radiation area is greater than the second radiation area, and a range of the third radiation area is greater than the second radiation area, the second radiation area forms the flattened detection area, the wireless signal detection method further comprises:
determining whether the external object is located in the first radiation area, the second radiation area or the third radiation area;
generating position information according to the internal signal when the external object is located in the second radiation area;
displaying a mark corresponding to the external object according to the position information; and
not displaying the mark when the external object is located in the first radiation area or the third radiation area.

19. The wireless signal detection method according to claim 17, wherein the narrow-beamwidth antenna radiation pattern comprises a first radiation area, a second radiation area and a third radiation area, the second radiation area is located between the first radiation area and the third radiation area, a range of the first radiation area is greater than the second radiation area, and a range of the third radiation area is greater than the second radiation area, the second radiation area forms the flattened detection area, wherein the external object comprises two objects, the wireless signal detection method further comprises:
determining whether the two objects are located in the first radiation area, the second radiation area or the third radiation area;
generating relative distance information of the two objects in the second plane according to the internal signal when the two objects are located in the second radiation area.

20. The wireless signal detection method according to claim 17, wherein transmitting the transmission signal comprises:
transmitting a first sub-transmission signal via a first transmitting antenna group,
transmitting a second sub-transmission signal via a second transmitting antenna group, wherein the first transmitting antenna group and the second transmitting antenna group are arranged along a second direction, and the transmission signal comprises the first sub-transmission signal and the second sub-transmission signal,
changing a phase difference between the first sub-transmission signal and the second sub-transmission signal so that distribution of the narrow-beamwidth antenna radiation pattern in the second plane is rotated and changed around an axis extending along a first direction, wherein a second included angle between the first direction and a normal direction of the second plane is greater than or equal to 0 degrees and less than or equal to 10 degrees.
